(19) United States
(12) Patent Application Publication
(10) Pub. No.: US 2025/0320577 A1
(43) Pub. Date: Oct. 16, 2025

(54) METHOD FOR REMOVING METAL AND METHOD FOR RECOVERING METAL

(71) Applicant: JX METALS CIRCULAR SOLUTIONS CO., LTD., Tokyo (JP)

(72) Inventors: Yasufumi HAGA, Hitachi-shi (JP); Kei SHIKADA, Hitachi-shi (JP); Yujiro TOKITA, Hitachi-shi (JP); Hiroshi MIYANAGA, Hitachi-shi (JP)

(73) Assignee: JX METALS CIRCULAR SOLUTIONS CO., LTD., Tokyo (JP)

(21) Appl. No.: 18/866,412

(22) PCT Filed: Sep. 26, 2023
(86) PCT No.: PCT/JP2023/035036

§ 371 Date: Nov. 15, 2024

(30) Foreign Application Priority Data
Sep. 29, 2022 (JP) 2022-157075

(51) Int. Cl. C22B 1/00; C22B 7/00; C22B 21/00; H01M 10/54

(52) U.S. Cl. CPC C22B 1/005; C22B 7/008; C22B 21/0007; C22B 21/0023; H01M 10/54

(57) ABSTRACT

Provided are a method for removing at least one metal that can effectively remove metals from lithium ion battery waste, and a method for recovering metals. A method for removing at least one metal from lithium ion battery waste, wherein the lithium ion battery waste has a cathode material with cathode-derived metals adhering onto a cathode current collector containing aluminum, the aluminum being a metal to be removed, wherein the method includes, in any order: a crushing step of crushing the lithium ion battery waste and separating at least a part of the cathode-derived metals from the cathode current collector; and an alkali separation step of separating at least a part of the cathode-derived metals from the cathode current collector by bring the lithium ion battery waste into contact with an alkaline solution to dissolve the aluminum, wherein the method further includes, after the crushing step, a sieving step of sieving the lithium ion battery waste into a material on sieve and a material under sieve containing the cathode-derived metals separated from the cathode current collector in the crushing step, and wherein, when the sieving step is performed before the alkali separation step, at least a part of the material on sieve obtained in the sieving step is subjected to the alkali separation step.

### TECHNICAL FIELD

This specification relates to a method for removing a metal(s) from lithium ion battery waste and a method for recovering metals.

### BACKGROUND ART

Vehicles such as hybrid vehicles, fuel cell vehicles, and electric vehicles are equipped with a vehicle battery pack that supplies electric power to an electric motor as a drive source (see, for example, Patent Literatures 1 to 6). In the vehicle battery pack, battery cells may be housed inside a frame forming the skeleton of the exterior. In addition, many vehicle battery packs are made by bundling a plurality of battery cells to form a battery module, and connecting a plurality of battery modules together. Also, the vehicle battery pack may further include a BMS (Battery Management System) for monitoring each battery cell, a cooling device for cooling the battery, wires for connect them, and the like.

For the battery cells of the above vehicle battery pack, a secondary battery capable of storing electricity by charging and of repeated use, especially a nickel hydrogen battery, has generally been used. In recent years, a lithium ion battery has been used which employs a lithium transition metal composite oxide for a cathode. The lithium ion battery may be provided with a cathode material in which a cathode active material containing valuable metals such as cobalt is attached onto a cathode current collector such as an aluminum foil. Therefore, if the vehicle battery pack is disposed after use or the like, it is desirable that the valuable metals which may be contained in the lithium ion battery waste is easily recovered for recycling at a relatively low cost, in terms of effective use of resources.

Processes for recovering valuable metals from lithium ion battery waste, which is not limited to waste of vehicle lithium ion batteries, include a preliminary process such as a heat treatment, crushing, and sieving of lithium ion battery waste, and a wet process for a powder obtained after the preliminary process.

Specifically, in the wet process, metals such as cobalt, nickel, manganese, lithium, aluminum, and iron in the powder are leached with an acid to obtain a metal-containing solution in which the metals are dissolved. Aluminum ions, iron ions, manganese ions, and the like are then sequentially or simultaneously removed from the metal-containing solution by neutralization or solvent extraction, for example, as described in Patent Literature 7. Cobalt ions and nickel ions in the metal-containing solution are then separated by solvent extraction. After separating the nickel ions by extraction, a metal-containing solution in which lithium ions remain is obtained.

### CITATION LIST

### Patent Literature

PTL 1: Japanese Patent Application Publication No. 2006-179190 A
PTL 2: Japanese Patent Application Publication No. 2007-172938 A
PTL 3: U.S. Patent Application Publication No. 2007/0141454 A1
PTL 4: Japanese Patent Application Publication No. 2007-172939 A
PTL 5: U.S. Patent Application Publication No. 2007/0141455 A1
PTL 6: Japanese Patent Application Publication No. 2011-198713 A
PTL 7: WO 2018/181816 A1

### SUMMARY OF INVENTION

### Technical Problem

By the way, the lithium ion battery waste described above may have a cathode material in which a cathode active material strongly adheres or binds onto a cathode current collector, and it is difficult to separate the cathode active material from the cathode current collector. In such lithium ion battery waste, the cathode current collector is not sufficiently removed even by crushing or sieving, so that a relatively large amount of aluminum contained in the cathode current collector may be mixed into the powder.

When the aluminum mixed into the powder is leached with an acid, it is dissolved together with other metals such as cobalt to form aluminum ions, which will be contained in the metal-containing solution. When the metal-containing solution contains relatively large amounts of aluminum ions, it will be difficult to sufficiently remove them. Therefore, it is desirable to remove metals such as aluminum before leaching the metals in the powder with an acid.

This specification provides a method for removing at least one metal that can effectively remove the metal from lithium ion battery waste, and a method for recovering metals.

### Solution to Problem

The method for removing a metal(s) disclosed in this specification is a method for removing at least one metal from lithium ion battery waste, wherein the lithium ion battery waste has a cathode material with cathode-derived metals adhering onto a cathode current collector containing aluminum, the aluminum being a metal to be removed, wherein the method comprises, in any order: a crushing step of crushing the lithium ion battery waste and separating at least a part of the cathode-derived metals from the cathode current collector; and an alkali separation step of separating at least a part of the cathode-derived metals from the cathode current collector by bring the lithium ion battery waste into contact with an alkaline solution to dissolve the aluminum, wherein the method further comprises, after the crushing step, a sieving step of sieving the lithium ion battery waste into a material on sieve and a material under sieve comprising the cathode-derived metals separated from the cathode current collector in the crushing step, and wherein, when the sieving step is performed before the alkali separation step, at least a part of the material on sieve obtained in the sieving step is subjected to the alkali separation step.

The method for recovering metals disclosed in this specification recovers metals from a powder obtained by removing a metal to be removed from lithium ion battery waste by the method for removing at least one metal described above.

### Advantageous Effects of Invention

According to the method for removing the metal(s) described above, at least one metal can be effectively removed from lithium ion battery waste.

### BRIEF DESCRIPTION OF DRAWINGS

FIG. 1 is a flow chart illustrating an embodiment of a method for removing a metal(s).

FIG. 2 is a flow chart illustrating a method for removing a metal(s) according to another embodiment.

FIG. 3 is a flow chart illustrating a method for removing a metal(s) according to still another embodiment.

FIG. 4 is a flow chart illustrating an example of a method for recovering metals from a powder obtained by the method for removing a metal(s).

### DESCRIPTION OF EMBODIMENTS

Embodiments of the method for removing a metal(s) and the method for recovering metals as described above will be described below in detail.

A method for removing a metal(s) according to an embodiment is a method for removing at least one predetermined metal from lithium ion battery waste. The lithium ion battery waste contains a cathode material in which cathode-derived metals adhere onto a cathode current collector, and the cathode current collector contains aluminum such as aluminum foils. The metal to be removed in this embodiment is at least aluminum. The Lithium ion battery waste may also include anode materials having anode current collectors containing copper such as copper foils. In this case, the metal to be removed in this embodiment may further include copper.

The above method for removing at least one metal includes a crushing step and an alkali separation step in any order, as well as a sieving step after the crushing step. Either the crushing step or the alkali separation step may be first performed, and other step(s) may be included between the crushing step and the alkali separation step. In the crushing step, the lithium ion battery waste is crushed and at least a part of the cathode-derived metals is separated from the cathode current collector. The cathode-derived metals separated from the cathode collector in the crushing step are sieved into a material under sieve in the subsequent sieving step. In the alkali separation step, the lithium ion battery waste is brought into contact with an alkaline solution to dissolve aluminum of the cathode current collector. Here, the aluminum on the surface of the cathode current collector to which the cathode-derived metals have adhered is dissolved to release the cathode-derived metals from the cathode current collector, or the aluminum making up the cathode current collector is substantially completely dissolved, whereby at least a part of the cathode-derived metals is separated from the cathode current collector. After the alkali separation step, a solid-liquid separation step may be performed to remove the aluminum-containing solution obtained in the alkali separation step.

The separation of the cathode-derived metals from the cathode current collector may be insufficient by either the crushing step or the alkali separation step. In contrast, in this embodiment, both the crushing step and the alkali separation step are performed, so that most of the cathode-derived metals are separated from the cathode current collector. As a result, the aluminum of the cathode current collector, which is the metal to be removed, can be effectively removed from the lithium ion battery waste.

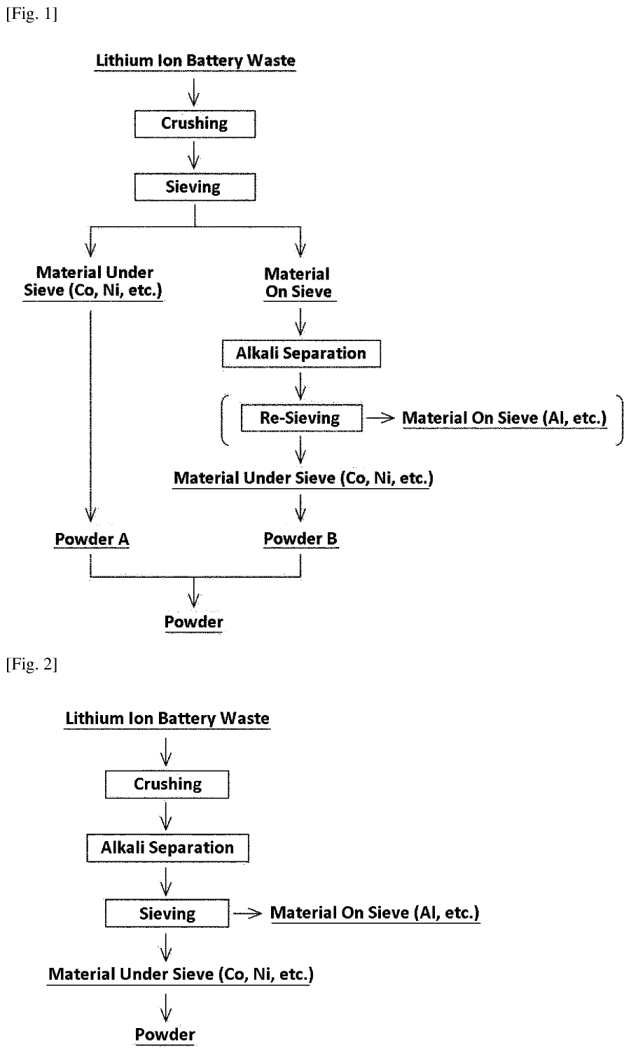

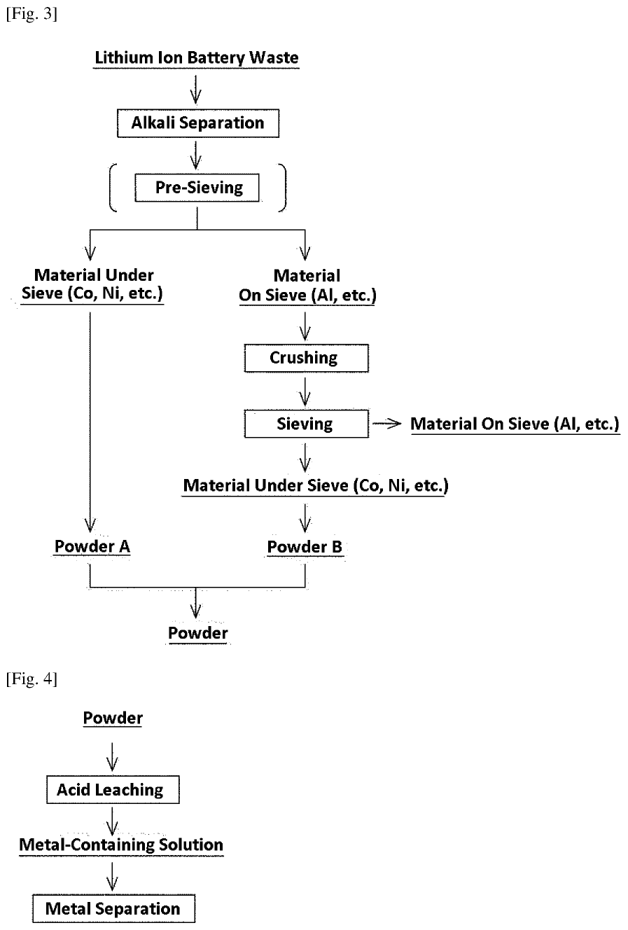

The present invention includes embodiments of the flows shown in FIGS. 1 to 3 where the order of the crushing and alkali separation steps and the timing of the sieving step are different. In both FIGS. 1 and 2, the alkali separation step is performed after the crushing step, but they are different from each other in that the sieving step is performed between the crushing step and the alkali separation step in FIG. 1, and the sieving step is performed after the alkali separation step in FIG. 2. In FIG. 3, the crushing step is performed after the alkali separation step, and the alkali separation step, the crushing step and the sieving step are performed in this order. If the alkali separation step is performed after the crushing step as shown in FIGS. 1 and 2, a series of steps can be smoothly carried out, which is preferable, for example, because the drying after the alkali separation step in the case of FIG. 3, which is performed in the reverse order, becomes unnecessary, or the like. Further, when the alkali separation step is performed after the crushing step, the surface area of the lithium ion battery waste brought into contact with the alkaline solution in the alkali separation step increases. Therefore, from the viewpoint of effectively performing the alkali separation step, it is preferable to perform the crushing step first. Although detailed descriptions are omitted herein, at any time before obtaining the powder from the lithium ion battery waste, a heat treatment step may be carried out by heating the lithium ion battery waste at a temperature of 350° C. to 650° C. for 1 hour to 8 hours.

Hereinafter, details of each step will be first described along the flow chart shown in FIG. 1, and supplementary descriptions of mainly different points from FIG. 1 will be then given for FIGS. 2 and 3.

### (Lithium Ion Battery Waste)

The lithium ion battery waste can be waste of various vehicle lithium ion batteries which can be installed in vehicles such as hybrid vehicles, fuel cell vehicles, and electric vehicles, and which have been discarded due to vehicle scrapping, battery re-placement or manufacturing defects, or other reasons. The lithium ion battery waste refers to lithium ion batteries subject to recycling, regardless of whether the lithium ion batteries are traded for profit, at no charge, or as industrial waste.

The lithium ion batteries included in such lithium ion battery waste include cathode materials, anode materials, electrolytes, and aluminum housings surrounding them. Here, the cathode material and the anode material may be formed by attaching a cathode active material or an anode active material onto a cathode current collector such as aluminum foils or an anode current collector such as copper foils, respectively, for example, by polyvinylidene fluoride (PVDF) or other organic binder.

Among them, the cathode active material uses, for example, a single metal oxide of one of lithium, nickel, cobalt and manganese, or a composite metal oxide of two or more of them. Examples of such a cathode active material include LiCoO₂, LiNiO₂, Li—Co—Ni—O₂, Li—Co—Ni—Mn—O, and the like. It is desirable to recover the metals contained in the cathode active material as valuable metals in terms of effective utilization of resources. The metal contained in the cathode active material can change its form from the above oxide by processes as described below or the like, but regardless of the form, metals such as cobalt, nickel, and lithium derived from the cathode active materials (hereinafter also referred to as “cathode-derived metals”) are to be recovered herein.

A carbon-based material is often used for the cathode active material, and an electrolytic solution such as ethylene carbonate or diethyl carbonate is often used for the electrolyte. Further, the vehicle lithium ion battery waste may include terminals containing copper and/or iron, iron housings, stainless steel housings, and the like.

The vehicle lithium ion battery waste has a frame made of a metal such as iron as an exterior skeleton, and battery cells, which are lithium ion batteries, housed inside the frame. This type of lithium ion battery waste often contains a plurality of battery cells, which are formed by bundling the battery cells together to form a battery module, and connecting a plurality of battery modules together.

The lithium ion battery waste can also include a BMS (Battery Management System) that monitors each battery cell, a cooling device that cools the battery, wires that connect them, and the like. The wires are those which are made of a metal including copper, such as copper (Cu wire), and the like, and which are connected to each battery cell and BMS, and transmit information (temperature, voltage, etc.) about a temperature, voltage, or the like of each battery cell to the BMS. In some cases, a resin member may be provided between or around the battery cells.

Further, the housing of the lithium ion battery waste generally contains an electrolytic solution having an electrolyte such as lithium hexafluorophosphate dissolved in an organic solvent. For example, ethylene carbonate, diethyl carbonate or the like may be used as the organic solvent.

There is some lithium ion battery waste in which the cathode active material is difficult to be separated from the cathode current collector such as aluminum foils. In contrast, in this embodiment, as will be described below, a preliminary process including a crushing step and an alkali separation step can be carried out to obtain a powder from which the aluminum of the cathode current collector has been effectively removed.

In this embodiment, lithium ion battery waste in which the form of the product as the lithium ion battery is maintained may be targeted, but process scrap may also be targeted. The process scrap is scrap which has been discarded from a production step of a lithium ion battery before injecting an electrolytic solution to construct the lithium ion battery and is at least free of the electrolytic solution. Typically, the process scrap does not contain the electrolytic solution, as well as aluminum housings and copper-containing terminals. Specific examples of the process scrap include a cathode material in which a cathode active material is attached onto a cathode current collector such as aluminum foils by an organic binder or the like, a laminated body in which a cathode material, an anode material and a separator are laminated, and a wound body obtained by winding up a cathode material, an anode material and a separator, and the like. In the production of the lithium ion battery, terminals are attached to the laminated body or the wound body to enclose it in the housing, and an electrolytic solution is then injected therein. Any material that is discarded from the step prior to the injection of the electrolytic solution and does not contain the electrolytic solution is defined as the process scrap. Such process scrap is also referred herein to as the lithium ion battery waste.

The lithium ion battery waste including aluminum housings and terminals containing copper often requires a magnetic force sorting to separate the terminals containing aluminum and copper derived from the housings from aluminum foils with cobalt attached. Further, in such lithium ion battery waste, cobalt and the like do not have magnetism in a form of a composite oxide in the cathode active material, so that it may be necessary to perform a heat treatment step before the magnetic force sorting to convert the cobalt and the like into the form having magnetism. On the other hand, the above process scrap that does not include the aluminum housings and copper-containing terminals may not require the heat treatment step for magnetizing cobalt or the like. For the process scrap containing the housings and terminals containing copper, the heat treatment step can be omitted if the thicknesses of the housings and terminals are thinner and can be crushed. However, it is desirable to perform the heat treatment step when it is difficult to crush it due to a larger thickness to some extent. When the heat treatment step is performed, lithium may be dissolved in an alkaline solution during the alkali separation step due to a change in the form of lithium, resulting in a loss of lithium. If the heat treatment step is not performed, lithium remains in a form that is difficult to be dissolved in the alkaline solution in the alkali separation step, and the loss of lithium is difficult to occur.

### (Crushing Step)

In the crushing step, the lithium ion battery waste is crushed and at least a part of the cathode-derived metals is separated from the cathode current collector.

Preferably, at least a part of the cathode material is sheared by the crushing. When the cathode material is sheared, the cathode-derived metals tend to be easily separated from the cathode current collector, because the cathode-derived metals adhering to the cathode current collector is scraped off during the shearing. It should be noted that if the cathode current collector is pulverized, the mixed amount of aluminum contained in the cathode current collector may increase. When the lithium ion battery waste is the process scrap of the laminated body or the wound body, not only the cathode material but also the anode material and the separator are often sheared by the crushing.

Especially in the case of the lithium ion battery waste of the process scrap, when the crushing step and the alkali separation step are performed in this order, the cathode material is sheared in the crushing step so that the cathode current collector made finer to some extent is effectively dissolved in the alkali separation step described below, and the cathode-derived metals will be easily separated therefrom. Further, with the process scrap that does not include housings and terminals, the above shearing of the cathode material in the crushing step can be effectively performed without being hindered by the housings and the terminals.

Various types of crushers can be used for such crushing, and among them, a shearing crusher can preferably be used. This is because the cathode material is sheared as described above. It is concerned that a crusher such as a hammer mill and a pin mill, which aims only at making finer particles, may pulverize the cathode current collector.

The lithium ion battery waste, the cathode current collector, and the cathode material in this specification and claims include those which have become fine to some extent, such as fragments, due to being crushed in the crushing step, for example.

### (Sieving Step)

The sieving step is performed after the crushing process, and sieves the lithium ion battery waste into a material on sieve, and a material under sieve, which contains the cathode-derived metals separated from the cathode current collector in the crushing step. If the sieving step is performed after the crushing step, other steps may be performed between those steps.

In the sieving step, a sieve having a predetermined sieve opening is used. The sieve opening of the sieve can be, for example, 0.15 mm to 1 mm, and preferably 0.25 mm to 0.425 mm.

The lithium ion battery waste as the material on sieve sorted in the sieving step also includes, for example, cathode materials and the like, to which the cathode-derived metals still adhere onto the cathode current collector without being separated from the cathode current collector in the crushing step, and also includes valuable metals such as nickel and cobalt together with aluminum. For such lithium ion battery waste (the material on sieve), the alkali separation step described below is performed in order to further separate the cathode-derived metals from the cathode current collector to remove aluminum and to recover the valuable metals.

On the other hand, the material on sieve mainly contains the cathode-derived metals separated from the cathode current collector in the crushing step. In some cases, the aluminum content of the material on sieve can be sufficiently reduced. Therefore, the material on sieve can be subjected to an acid leaching step and a metal separation step as a powder A, which will be described below, to recover cobalt, nickel, and the like.

### (Alkali Separation Step)

In the alkali separation step, the lithium ion battery waste (in the case of FIG. 1, at least a part of the material on sieve obtained in the sieving step) is brought into contact with an alkaline solution. The contact with the alkaline solution dissolves aluminum in the cathode current collector and the like of the lithium ion battery waste. In this case, for example, the surface of the cathode current collector to which the cathode-derived metals adhere is dissolved, or the like, so that at least a part of the cathode-derived metals are released from the cathode current collector. Alternatively, the cathode current collector may substantially completely be dissolved in the alkaline solution. As a result, at least a part of the cathode-derived metals can be separated from the cathode current collector.

Whether only the surface of the cathode current collector is dissolved or the cathode current collector is substantially completely dissolved can be adjusted by changing a contact time between the lithium ion battery waste and the alkaline solution, or an alkali concentration of the alkaline solution. Different cathode current collectors of the lithium ion battery waste may have different resistances to alkali. If the cathode current collector and the cathode material are expected to be easily separated by alkali, the cathode-derived metals can be released from the cathode current collector by shortening the contact time or reducing the alkali concentration. Alternatively, if the releasing is not easy, the cathode current collector may be dissolved by lengthening the contact time or increasing the alkali concentration.

As shown in FIG. 1, when the alkali separation step is performed after the crushing step, the cathode current collector in the cathode material becomes finer to some extent due to the shearing of the cathode material in the crushing step. When the lithium ion battery waste containing such a cathode current collector is subjected to the alkali separation step, the alkaline solution tends to be in contact with many portions of the cathode current collector. This promotes the separation of the cathode-derived metals from the cathode current collector. The same is true for FIG. 2.

Also, when the crushing step, the sieving step, and the alkali separation step are performed in this order, only the material on sieve obtained in the sieving step is subjected to the alkali separation step, so that the amounts of chemicals and the costs of the chemicals in the alkali separation step can be reduced.

The mode where the lithium ion battery waste is brought into contact with the alkaline solution is not particularly limited as long as at least a part of the aluminum can be dissolved by the contact to separate at least a part of the cathode-derived metals from the cathode current collector. Examples of the mode include immersing the lithium ion battery waste in the alkaline solution, and pouring the alkaline solution over the surface of the cathode current collector to which the cathode-derived metals of the lithium ion battery waste adhere, and the like.

The alkaline solution to be brought into contact with the lithium ion battery waste preferably has a pH of 13.0 or more before the contact. Also, before the contact with the lithium ion battery waste, the alkaline solution preferably has a concentration of OH⁻ of 5 mol/L or less. The alkaline solution may maintain the pH of 13.0 or more and the concentration of OH of 5 mol/L or less after the contact with lithium ion battery waste. If the alkaline solution having an excessively high pH is used, the alkaline solution dissolves most of the cathode current collector, even in the case of the lithium ion battery waste in which the cathode-derived metals can be released by dissolving a part of the cathode current collector, resulting in higher costs for a final effluent treatment. On the other hand, if the pH of the alkaline solution is too low, there is concern that aluminum will not be sufficiently dissolved. Examples of the alkaline solution that can be used herein include a sodium hydroxide solution, a potassium hydroxide solution, and the like.

Further, in the alkali separation step, the liquid temperature of the alkaline solution brought into contact with the lithium ion battery waste is preferably maintained in the range of 10° C. to 80° C., and more preferably in the range of 10° C. to 50° C. If the liquid temperature is too high, the reactivity will increase, causing a risk of sudden generation of hydrogen or a sudden rise in the liquid temperature. If the liquid temperature is too low, the reactivity will decrease so that the alkali separation process may take a long period of time. A pulp density can be, for example, from 20 g/L to 500 g/L. The pulp density refers to a ratio of a dry weight (g) of the lithium ion battery waste to an amount of the alkaline solution (L) to be brought into contact with the lithium ion battery waste. A time for dissolving aluminum may be, for example, 0.5 hours to 3.0 hours.

If the heat treatment step is not performed before the alkali separation step, the lithium in the lithium ion battery waste may not be converted into a form such as lithium carbonate that will be dissolved in the alkaline solution, so that the form of the above single or composite metal oxide may be maintained. In this case, in the alkali separation step, lithium in the lithium ion battery waste is hardly soluble in the alkaline solution. Therefore, from the viewpoint of suppressing a loss of lithium in the alkali separation step, the method for removing the metal preferably does not include the heat treatment step.

After the alkali separation step, an aluminum-containing solution in which the aluminum in the lithium ion battery waste has been dissolved, and a fragment-like or powder-like residue left undissolved by the contact with the alkaline solution are obtained. The aluminum-containing solution can be separated and removed in a solid-liquid separation step as described below. The aluminum-containing solution can have an aluminum ion concentration of, for example, 0.7 g/L to 6 g/L.

When the surface of the cathode current collector is dissolved in the alkali separation step, the residue as described above may include not only the cathode-derived metals in the form of powder or the like, but also the cathode collector such as the aluminum foil in the form of fragments or the like, from which the cathode-derived metals have been separated. For the purpose of separating and removing such a cathode current collector from the cathode-derived metals, it is preferable to perform a re-sieving step as described below. Alternatively, when the cathode current collector is substantially completely dissolved in the alkali separation step, the residue as described above may not contain the cathode current collector. In this case, the re-sieving step can be omitted.

### (Re-Sieving Step)

In the re-sieving step, the residue obtained after the alkali separation step is sieved, and the residue is sorted into a material on sieve containing the cathode current collector from which the cathode-derived metals have been separated in the alkali separation step, and a material under sieve containing the cathode-derived metals separated from the cathode current collector in the alkali separation step. The material under sieve mainly contains valuable metals such as cobalt and nickel, and can be used as a powder B to be subjected to an acid leaching step.

By the alkali separation step as described above, the cathode-derived metals are effectively released from the cathode current collector. The cathode current collector has a shape such as a fragment shape, and may have a larger size than the cathode-derived metals. Therefore, if a sieve having an appropriate sieve opening is selected and used in the re-sieving step, the aluminum-containing cathode current collector can be satisfactorily removed as a material on sieve. At this time, not only the cathode current collector but also the anode current collector and the separator made of copper or the like, which have large sizes similarly to the cathode current collector, may be included in the material on sieve and removed.

The sieve opening of the sieve used in the re-sieving step is, for example, 0.15 mm to 1 mm, and preferably 0.25 mm to 0.425 mm.

When the solid-liquid separation step is performed after the re-sieving step, in the resieving step, the residue obtained after the alkali separation step can be subjected to wet sieving while containing the residue in the aluminum-containing solution. When performing the solid-liquid separation step before the re-sieving step, in the re-sieving step, the residue obtained after the aluminum-containing solution has been separated in the solid-liquid separation step can be subjected to dry sieving.

### (Solid-Liquid Separation Step)

After the alkali separation step, the re-sieving step is performed in some cases, and a solid-liquid separation step may be then performed to separate and remove the aluminum-containing solution from the residue obtained in the alkali separation step (the material under sieve in the case after the re-sieving step).

The solid-liquid separation can be carried out by filtration or the like using a known device such as a filter press or a thickener.

The powder obtained as described above may have a lithium content of 5% to 6% by mass, a cobalt content of 2% to 20% by mass, a nickel content of 18% to 46% by mass, a manganese content of 0.1% to 15% by mass, an aluminum content of 0.1% to 3.0% by mass, and an iron content of 0% by mass.

### Other Embodiments

In the embodiment as shown in FIG. 2, the crushing step, the alkali separation step, and the sieving step are performed in this order. When the surface of the cathode current collector is dissolved and the cathode-derived metals are released from the cathode current collector in the alkali separation step, in the subsequent sieving step, the residue obtained after the alkali separation step can be sieved into a material on sieve containing the cathode current collector from which the cathode-derived metals have been separated in each of the crushing step and the alkali separation, and a material under sieve containing the cathode-derived metals separated from the cathode current collector in each of the crushing step and the alkali separation step.

Alternatively, in FIG. 2, when the alkali separation step is performed under conditions where the cathode current collector is substantially completely dissolved, the residue obtained after the alkali separation step does not substantially contain the cathode current collector, but it may contain the anode current collector containing copper. The anode current collector contains copper which is a metal to be removed, and is crushed in the crushing step before the alkali separation step, and is included in the residue without being dissolved in the alkaline solution in the alkali separation step. In this case, the subsequent sieving step can be performed by sieving the residue obtained after the alkali separation step into a material on sieve containing the anode current collector crushed in the crushing step, and a material under sieve containing the cathode-derived metals separated from the cathode current collector in the crushing step.

Although not shown in FIG. 2, the solid-liquid separation step can be performed after the alkali separation step and before or after the sieving step. When the solid-liquid separation step is performed before the sieving step, the sieving step can be dry sieving, and when the solid-liquid separation step is performed after the sieving step, the sieving step can be wet sieving.

In the embodiment shown in FIG. 3, the alkali separation step, the crushing step, and the sieving step are performed in this order. Here, a pre-sieving step may be performed between the alkali separation step and the crushing step. In the pre-sieving step, it is sieved into a material on sieve containing the cathode current collector from which the cathode-derived metals have been separated in the alkali separation step and a material under sieve containing the cathode-derived metals separated from the cathode current collector in the alkali separation step.

In order to be separated into the material on sieve and the material under sieve, the sieve used in the pre-sieving step has a sieve opening of, for example, 0.15 mm to 1 mm, and preferably 0.25 mm to 0.425 mm. The material on sieve obtained in the pre-sieving step contains the cathode current collector in which the cathode-derived metals have remained, and at least a part thereof is subjected to a crushing step to recover the cathode-derived metals therefrom. On the other hand, the material under sieve can be powder A.

When the pre-sieving step is performed, in the sieving step after the crushing step, it is sieved into a material on sieve containing the cathode current collector from which the cathode-derived metals have been separated in the crushing step and a material under sieve containing the cathode-derived metals separated from the cathode current collector in the crushing step.

However, for example, when the cathode current collector is substantially completely dissolved in the alkali separation step, the pre-sieving step can be omitted. When the pre-sieving step is not performed, the residue obtained after the alkali separation step is subjected to the crushing step. In this case, in the sieving step after the crushing step, the anode current collector and the like crushed in the crushing step can be sieved as the material on sieve. The material under sieve contains the cathode-derived metals separated from the cathode current collector in the crushing step, and can be used as a powder B.

### (Acid Leaching Step)

In the acid leaching step, metals in the powder are leached with an acid by adding the above powder to an acidic leaching solution of sulfuric acid, nitric acid, hydrochloric acid or other inorganic acid. This provides a metal-containing solution in which various metals are dissolved.

The acid leaching step can be performed by a known method or conditions, but preferably at a pH of 0.0 to 2.0, and at an oxidation-reduction potential (ORP, based on silver/silver chloride potential) of 0 mV or less.

When the powder is obtained from the lithium ion battery waste without performing the heat treatment step, lithium may be contained in the powder in the form of the composite metal oxide as described above. In this case, it is desirable to add a reducing agent such as hydrogen peroxide to the acidic leaching solution in order to dissolve such a composite metal oxide.

The residue left undissolved by the acid leaching can be separated from the metal-containing solution by solid-liquid separation such as filtration using a known device and method such as a filter press and a thickener. There is a case where most of the copper in the powder can be contained in the leached residue. The solid-liquid separation can be omitted, and neutralization or the like in the metal separation step may be performed after the acid leaching without the solid-liquid separation.

The metal-containing solution obtained in the acid leaching step may contain at least one selected from the group consisting of lithium ions, cobalt ions, nickel ions, manganese ions, aluminum ions, iron ions and copper ions, typically cobalt ions and/or nickel ions.

The metal-containing solution obtained in the acid leaching step has a cobalt ion concentration of 10 g/L to 50 g/L, a nickel ion concentration of 10 g/L to 50 g/L, a manganese ion concentration of 0 g/L to 50 g/L, an aluminum ion concentration of 1.0 g/L to 20 g/L, an iron ion concentration of 0.1 g/L to 5.0 g/L, a copper ion concentration of 0.005 g/L to 0.2 g/L, and a fluoride ion concentration of 0.01 g/L to 20 g/L.

### (Metal Separation Step)

In the metal separation process, metals such as cobalt and nickel can be separated from the metal-containing solution by various known methods, and required metals can be recovered from those metals. Specifically, the metal-containing solution can be neutralized and/or solvent-extracted to separate and recover the metals in the metal-containing solution.

### Test Example

As a test relating to the method for removing the metal as described above, the following test example was conducted. Descriptions of this test example are merely illustrative and are not limited.

We tried to separate the cathode-derived metals from the cathode current collector of the cathode material, by subjecting process scraps A to C, as lithium-ion battery waste, of cathode materials that did not contain any electrolytic solution, aluminum housings, and terminals containing copper, to crushing and sieving or alkali separation. Here, the process scraps A to C are different from each other in the composition and structure making up the cathode material and in the production method thereof. In this test example, for each of the process scraps A to C, multiple samples were collected from the process scrap, one sample was subjected to crushing and sieving only, and the other sample was subjected to alkali separation only. The crushing and sieving correspond to the crushing step and the sieving step in FIGS. 1 to 3. That is, in the crushing and sieving, after performing the crushing step, the cathode-derived metals and the like separated from the cathode current collector in the crushing step were separated under the sieve, and the cathode current collector and the like were separated on the sieve in the sieving step. Specifically, in the crushing and sieving, one of the samples was crushed by shearing using HM-20 manufactured by Orient Crushing Machine Co., Ltd., as a crusher, and then sieved using a sieve having a sieve opening of 0.25 mm to obtain a material under sieve. In the alkali separation, a solution having a concentration of sodium hydroxide of 50 g/L and a pH of 14 was used as the alkaline solution, and the other of the samples was immersed in the alkaline solution for 10 to 30 minutes.

Table 1 shows a recovery rate, grade and loss of each metal in the materials under sieve obtained by the crushing and sieving and the residues obtained by the alkali separation. In Table 1, “%” is on a mass basis, and each of the recovery rate and the loss means an amount after processing relative to a content in each of the process scraps A to C before processing. Further, as described above, the “Alkali Releasing” in Table 1 means alkali separation in which the cathode-derived metals are released from the cathode current collector by dissolving aluminum on the surface of the cathode current collector.

TABLE 1

| | Crushing and Sieving | | Alkali Releasing | | |
|---|---|---|---|---|---|
| | Ni, Co | | Ni, Co | | |
| | Recovery | Al | Recovery | Al | Li |
| | Rate | Grade | Rate | Grade | Loss |
| Process Scrap A | 85% | 0.2% | >99% | <1% | <3% |
| Process Scrap B | 93% | <0.1% | >99% | <1% | <3% |

| | | | |
|---|---|---|---|
| Process Scrap C | >95% | 1.0% | Not Released |

As can be seen from Table 1, for the process scrap B, nickel, cobalt, and lithium could be effectively separated from aluminum in both crushing and sieving and the alkali separation, and the aluminum grade in each of the material under sieve and the residue was lower. Also, the loss of lithium could be suppressed at a lower level. However, for the process scrap A, nickel, cobalt, and lithium could be effectively separated from aluminum by the alkali separation, but they could not be sufficiently separated by the crushing and sieving, and the recovery rate of nickel and cobalt were lower, and the aluminum grade of the material under sieve was higher. For the process scrap C, cobalt, nickel, and lithium were not separated from the aluminum foil in the alkali separation, but nickel, cobalt, and lithium could be separated from aluminum in the crushing and sieving.

As described above, there are some process scraps from which nickel, cobalt, and lithium cannot be effectively separated from aluminum by only one of the crushing and sieving and the alkali separation. Further, whether effective separation can be achieved by the crushing and sieving or the alkali separation depends on the process scraps. However, even with such process scraps, nickel, cobalt, and lithium can be effectively separated from aluminum by performing one of the crushing and sieving and the alkali separation. In other words, if both the crushing and sieving and the alkali separation are performed, nickel, cobalt, and lithium can be effectively separated from aluminum in any of the steps regardless of the process scraps.

This suggests a possibility that aluminum can be effectively removed from the lithium ion battery waste according to the method for removing the metal as described above.

1. A method for removing at least one metal from lithium ion battery waste,
wherein the lithium ion battery waste has a cathode material with cathode-derived metals adhering onto a cathode current collector containing aluminum, the aluminum being a metal to be removed,
wherein the method comprises, in any order:
a crushing step of crushing the lithium ion battery waste and separating at least a part of the cathode-derived metals from the cathode current collector; and
an alkali separation step of separating at least a part of the cathode-derived metals from the cathode current collector by bring the lithium ion battery waste into contact with an alkaline solution to dissolve the aluminum,
wherein the method further comprises, after the crushing step, a sieving step of sieving the lithium ion battery waste into a material on sieve and a material under sieve comprising the cathode-derived metals separated from the cathode current collector in the crushing step, and
wherein, when the sieving step is performed before the alkali separation step, at least a part of the material on sieve obtained in the sieving step is subjected to the alkali separation step.

2. The method for removing at least one metal according to claim 1, wherein the alkaline solution brought into contact with the lithium ion battery waste in the alkali separation step has a pH of 13.0 or more.

3. The method for removing at least one metal according to claim 1, wherein the alkaline solution brought into contact with the lithium ion battery waste in the alkali separation step has a concentration of OH⁻ of 5 mol/L or less.

4. The method for removing at least one metal according to claim 1, wherein the alkaline solution has a liquid temperature of 10° C. to 80° C. in the alkali separation step.

5. The method for removing at least one metal according to claim 1, wherein the material on sieve obtained in the sieving step comprises the cathode current collector from which the cathode-derived metals have been separated in the crushing step.

6. The method for removing at least one metal according to claim 1, wherein the alkali separation step is performed after the crushing step.

7. The method for removing at least one metal according to claim 6, wherein the crushing step, the sieving step, and the alkali separation step are performed in this order.

8. The method for removing at least one metal according to claim 7, further comprising, after the alkali separation step, a re-sieving step of sieving a resulting residue in the alkali separation step into a material on sieve comprising the cathode current collector from which the cathode-derived metals have been separated in the alkali separation step, and a material under sieve comprising the cathode-derived metals separated from the cathode current collector in the alkali separation step.

9. The method for removing at least one metal according to claim 8, wherein the resieving step uses a sieve having a sieve opening of 0.15 mm to 1 mm.

10. The method for removing at least one metal according to claim 6, wherein the crushing step, the alkali separation step, and the sieving step are performed in this order.

11. The method for removing at least one metal according to claim 10,
wherein the lithium ion battery waste has an anode current collector containing copper, the copper being a metal to be removed, and
wherein the sieving step sieves the lithium ion battery waste into the material on sieve comprising the anode current collector crushed in the crushing step, and the material under sieve.

12. The method for removing at least one metal according to claim 1, wherein the alkali separation step, the crushing step, and the sieving step are performed in this order.

13. The method for removing at least one metal according to claim 12, further comprising, after the alkali separation step and before the crushing step, a pre-sieving step of sieving the resulting residue in the alkali separation step into a material on sieve comprising the cathode current collector from which the cathode-derived metals have been separated in the alkali separation step, and a material under sieve comprising the cathode-derived metals separated from the cathode current collector in the alkali separation step,
wherein at least a part of the material on sieve obtained in the pre-sieving step is subjected to the crushing step.

14. The method for removing at least one metals according to claim 13, wherein the pre-sieving step uses a sieve having a sieve opening of 0.15 mm to 1 mm.

15. The method for removing at least one metal according to claim 1, further comprising, after the alkali separation step, a solid-liquid separation step of removing an aluminum-containing solution obtained in the alkali separation step.

16. The method for removing at least one metal according to claim 1, wherein the sieving step uses a sieve having a sieve opening of 0.15 mm to 1 mm.

17. A method for recovering metals, comprising recovering metals from a powder obtained by removing a metal to be removed from lithium ion battery waste by the method for removing at least one metal according to claim 1.
